(19) United States
(12) Patent Application Publication
(10) Pub. No.: US 2007/0087126 A1
(43) Pub. Date: Apr. 19, 2007

(54) METHOD FOR MAKING A DECORATIVE LAMINATE

(76) Inventor: Leo Jaw, Hsin Kuang Village (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/539,099

(22) Filed: Oct. 5, 2006

(30) Foreign Application Priority Data
Oct. 14, 2005 (TW) 94136047

(51) Int. Cl. B32B 3/00

(52) U.S. Cl. 427/402; 428/156; 428/172

(57) ABSTRACT

Disclosed is a method for making an ultra thin decorative laminate. In the method, there is provided releasing paper with three-dimensional texture. A substrate is coated on the releasing paper. The releasing paper and the substrate are dried. An elastomer layer is coated on the substrate. The releasing paper, the substrate and the elastomer layer are dried so that the substrate and the elastomer layer are cured and become films. The releasing paper is removed so that three-dimensional texture on the substrate is exposed, thus finishing an ultra thin decorative laminate that can firmly attached to a curve face of a product.

### BACKGROUND OF INVENTION

1. Field of Invention

The present invention relates to package and, more particularly, to a method for making a decorative laminate for package.

2. Related Prior Art

A decorative sheet is often provided on a shell of a product or on a box for a product. Such a decorative sheet is often printed with patterns or textures for aesthetic purposes.

To get customers' attention, some decorative sheets are provided with three-dimensional textures. Conventionally, decorative sheets are printed with three-dimensional textures. There are however problems with such a method. Firstly, the effect is not impressive. Secondly, the thickness is significantly increased. Thirdly, colors fade away because of aging. Moreover, dirt easily stays on such three-dimensional textures, particularly after they are touched by customers. In addition, they easily absorb moisture and get deformed. Furthermore, such decorative sheets do not stick firmly to a curved face of a product and often get peeled from such a curved face of such a product.

Therefore, the present invention is intended to obviate or at least alleviate the problems encountered in prior art.

### SUMMARY OF INVENTION

According to the present invention, a method is disclosed for making an ultra thin decorative laminate. In the method, there is provided releasing paper with three-dimensional texture. A substrate is coated on the releasing paper. The releasing paper and the substrate are oven-dried. An elastomer layer is coated on the substrate. The releasing paper, the substrate and the elastomer layer are oven-dried so that the substrate and the elastomer layer are cured and become films. The releasing paper is removed so that three-dimensional texture on the substrate is exposed, thus finishing an ultra thin decorative laminate that can firmly attached to a curve face of a product.

An advantage of the method of the present invention is the provision of the impressive three-dimensional texture of the substrate.

Another advantage of the method of the present invention is the provision of the strong and durable ultra thin decorative laminate since the substrate is attached, by the adhesive layer, to the web that is made strong fibers.

Another advantage of the method of the present invention is the ultra thin decorative laminate that is beautiful, water-proof and not vulnerable to dirt since various pigments can be added to the substrate.

Another advantage of the method of the present invention is the provision of the ultra thin decorative laminate that can be attached to various products since the ultra thin substrate is excellently extensible.

Other advantages and features of the present invention will become apparent from the following description referring to the drawings.

### BRIEF DESCRIPTION OF DRAWINGS

The present invention will be described through detailed illustration of two embodiments referring to the drawings.

FIG. 1 is a flowchart of a method for making a decorative laminate according to the first embodiment of the present invention.

FIG. 2 is a cross-sectional view of a semi-product of the decorative laminate made in the method shown in FIG. 1.

FIG. 3 is a cross-sectional view of releasing paper being removed from the semi-product shown in FIG. 2.

FIG. 4 is a cross-sectional view of a final product of the decorative laminate made in the method shown in FIG. 1.

FIG. 5 is an enlarged perspective view of the final product shown in FIG. 4.

FIG. 6 is a flowchart of a method for making a decorative laminate according to the second embodiment of the present invention.

FIG. 7 is a simplified side view of a mechanism used in the method shown in FIG. 6.

FIG. 8 is a cross-sectional view of a semi-product of the decorative laminate made in the method shown in FIG. 6.

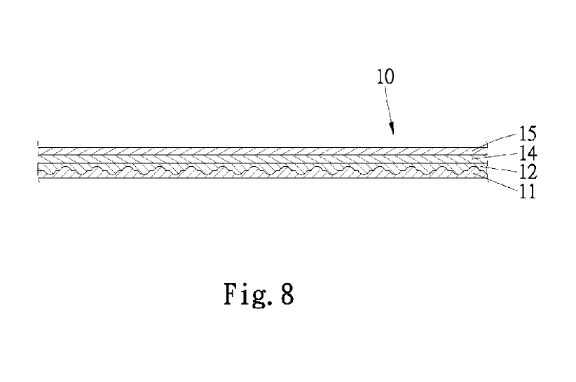

FIG. 9 is a cross-sectional view of releasing paper being removed from the semi-product shown in FIG. 6.

FIG. 10 is a cross-sectional view of a final product of the decorative laminate made in the method shown in FIG. 6.

FIG. 11 is an enlarged perspective view of the final product shown in FIG. 10.

### DETAILED DESCRIPTION OF EMBODIMENTS

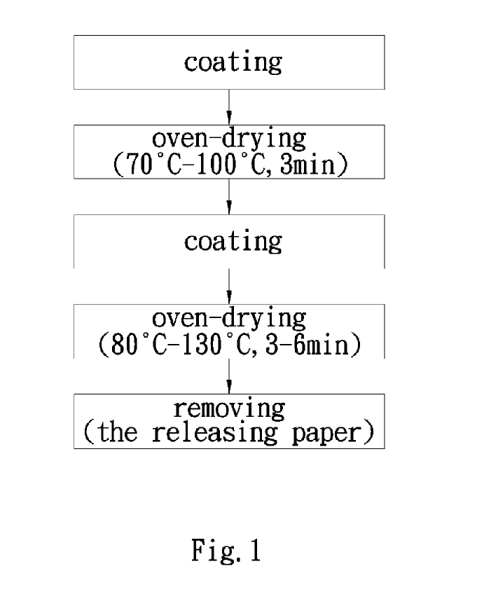

Referring to FIG. 1, there is shown a method for making a decorative laminate according to a first embodiment of the present invention.

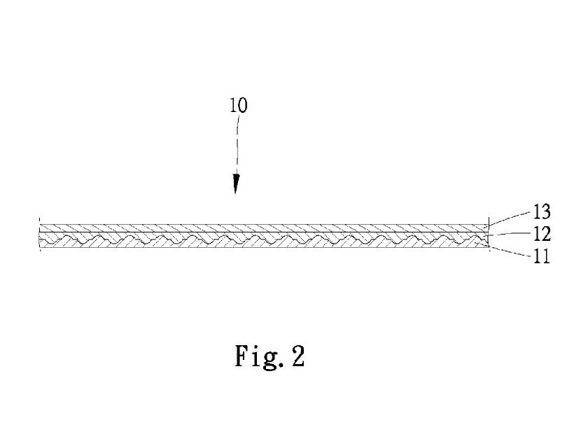

Referring to FIG. 2, there is provided releasing paper 11. The releasing paper 11 is formed with three-dimensional texture on a side. An ultra thin substrate 12 is coated on the releasing paper 11. The substrate 12 is made from polyurethane (“PU”) or other polymers such as thermoplastic polyurethane (“TPU”) and thermoplastic elastomer (“TPE”). Various pigments can be added to the substrate 12 for exhibiting different colors.

The releasing paper 11 and the substrate 12 are oven-dried at 70 to 100 degrees Celsius for 3 minutes. Thus, the substrate 12 is dried. When the substrate 12 is dried, its thickness is reduced.

An elastomer layer 13 is coated on the substrate 12. The elastomer layer 13 may be made from polyurethane resin, thermoplastic elastomer (“TPE”), thermoplastic rubber (“TPR”), thermoplastic polyurethane elastomer (“TPU”), thermoplastic vulcanized elastomer (“TPV”), styrene-butadiene rubber (“SBS”), styrene-ethylene-butylene-styrene elastomer (“SEBS”) or styrene-isoprene-styrene (“SIS”).

The releasing paper 11, the substrate 12 and the elastomer layer 13 are dried so that the substrates 2 and the elastomer layer 13 are cured and become films or foils. The drying is conducted at 80 to 130 degrees Celsius for 3 to 6 minutes. During this drying, the reaction of the elastomer layer 13 with the substrate 12 is expedited and the time for reaction is reduced. Then, the releasing paper 11, the substrate 12 and the elastomer layer 13 are laid for 12 to 48 hours so that the elastomer layer 13 and the substrate 12 are cured and become films or foils.

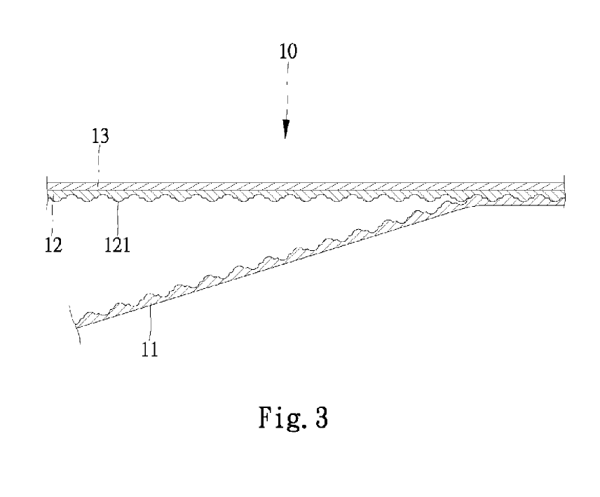

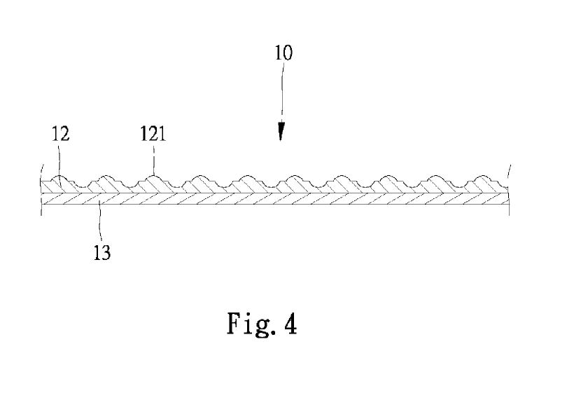

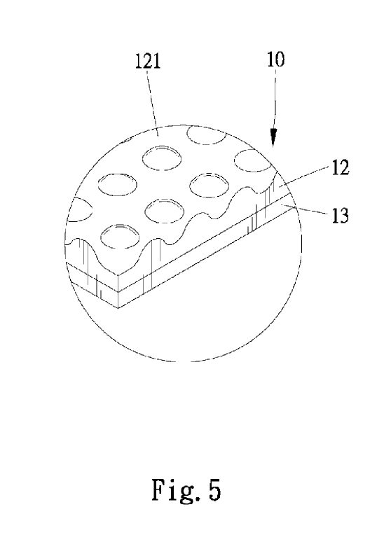

The releasing paper 11 is removed from the substrate 12 as shown in FIG. 3, leaving the substrate 12 and the elastomer layer 13 as shown in FIGS. 4 and 5. There is exposed three-dimensional texture 121 on the substrate 12. The three-dimensional texture 121 of the substrate 12 is in compliance with that of the releasing paper 11. The substrate 12 and the elastomer layer 13 together become a final product of the decorative laminate 10 according to the present invention. The thickness of the decorative laminate 10 is not larger than 0.1 mm and, more preferably, 0.05 mm.

Pressure-sensitive adhesive can be provided on the elastomer layer 13 of the decorative laminate 10 so that the decorative laminate 10 can be later adhered to an object.

The three-dimensional texture 121 of the substrate 12 is made in compliance with the three-dimensional texture of the releasing paper 11. The three-dimensional texture 121 exhibit an impressive aesthetic effect.

Since the substrate 12 is made from PU, it looks beautiful, does not get dirty easily and is water-proof, its colors last for a long period of time and its life is long.

Since the elastomer layer 13 is made from duo-solution resin or TPE, it is non-toxic, low polluting and recyclable. Duo-solution or TPE is used instead of polyvinylchloride (“PVC”) which is banned by more and more European countries. More and more famous brand-holders use TPE instead of PVC to make their products.

The time for making the decorative laminate 10 is little and waste can be recycled so that the cost of the decorative laminate 10 is low. The decorative laminate 10 is extensible so that it can firmly be attached to quality hand-made grips, toys, fixtures of vehicles and housing and electronic products.

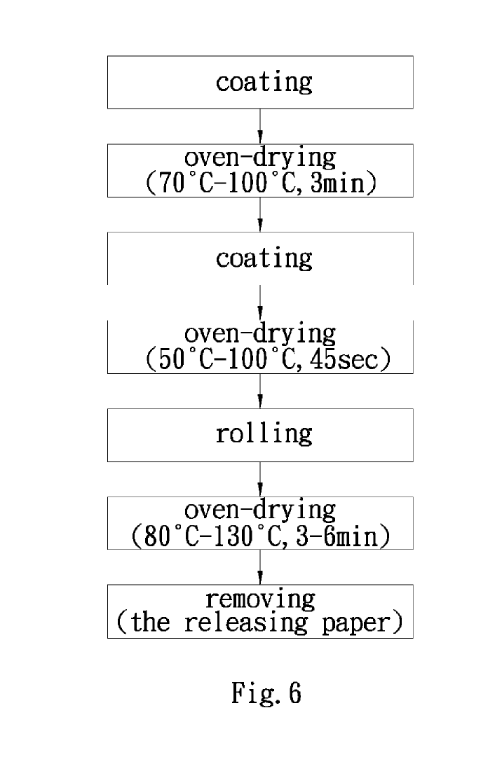

Referring to FIG. 6, there is shown a method for making a decorative laminate according to a first embodiment of the present invention.

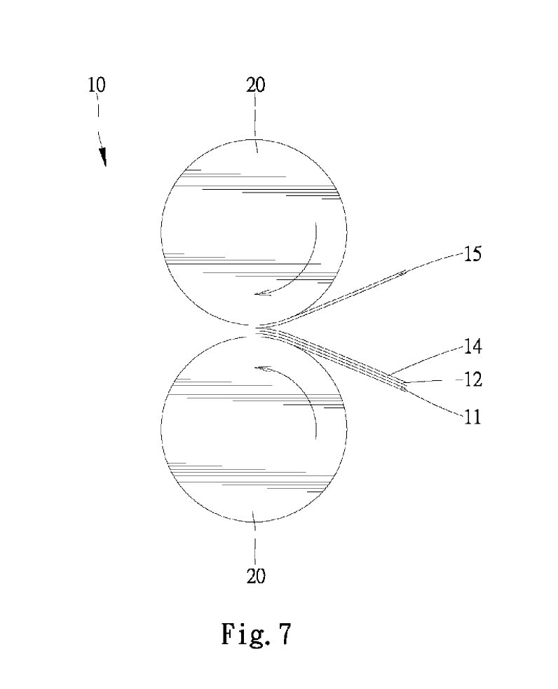

Referring to FIG. 7, there is provided releasing paper 11 formed with three-dimensional texture on a side. An ultra thin substrate 12 is coated on the releasing paper 11. The substrate 12 is made from polyurethane (“PU”) or other polymers such as single-solution PU, thermoplastic polyurethane (“TPU”) and thermoplastic elastomer (“TPE”). Various pigments can be added to the substrate 12 for exhibiting different colors.

The releasing paper 11 and the substrate 12 are dried at 70 to 100 degrees Celsius for 3 minutes. Thus, the substrate 12 is dried. When the substrate 12 is dried, its thickness is reduced.

An adhesive layer 14 is coated on the substrate 12. The adhesive layer 14 is made from PU or other polymers such as duo-solution PU, TPU and TPE.

The releasing paper 11, the substrate 12 and the adhesive layer 14 are dried at 50 to 100 degrees Celsius for 4 to 5 minutes so that solvent is vaporized and removed from the adhesive layer 14 while the adhesive layer 14 retains excellently adhesive.

A web 15 is attached to the adhesive layer 14 by a roller 20. The web 15 is fabric made of synthetic or natural fibers. The thickness of the web 15 is not larger than 0.20 mm. The fabric may be non-woven fabric. The roller 20 may or may not provide heat while rolling.

The releasing paper 11, the substrate 12, the adhesive layer 14 and the web 15 are dried and cured at 80 to 130 degrees Celsius for 3 to 6 minutes. During this drying, the reaction of the adhesive layer 14 with the substrate 12 is expedited and the time for reaction is reduced. Then, the releasing paper 11, the substrate 12 and the adhesive layer 14 are laid for 12 to 48 hours so that the adhesive layer 14 and the substrate 12 are cured and become films or foils.

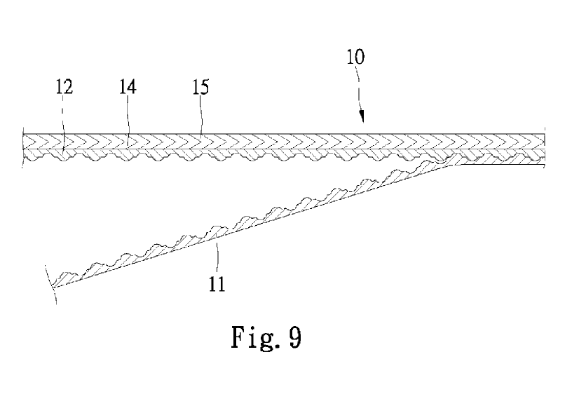

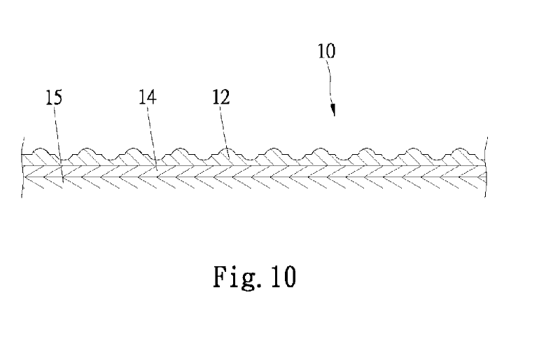

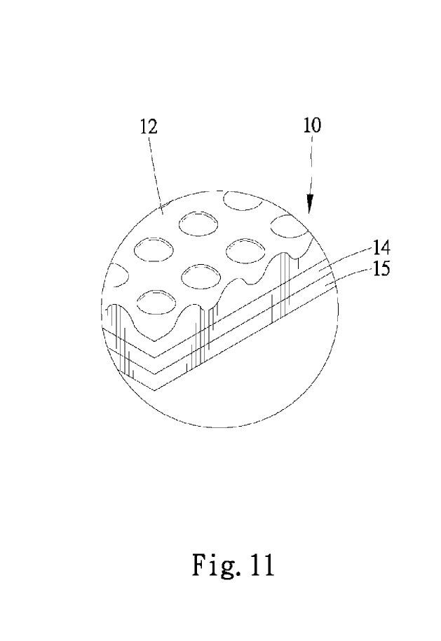

The releasing paper 11 is removed from the substrate 12 as shown in FIG. 9, leaving the substrate 12, the adhesive layer 14 and the web 15 as shown in FIGS. 10 and 11. A three-dimensional texture 121 of the substrate 12 is exposed. The substrate 12 and the adhesive layer 14 together become a final product of the decorative laminate 10 according to the present invention. The thickness of the decorative laminate 10 is not larger than 0.3 mm and, more preferably, 0.22 mm.

Pressure-sensitive adhesive can be provided on the web 15 of the decorative laminate 10 so that the decorative laminate 10 can be later adhered to an object.

Since the web 15 is made of non-woven fabric to which particles and liquid can easily be attached, the adhesive layer 14 can effectively be attached to the web 15 without the drawback of peeling.

Furthermore, the web 15 includes a low contraction rate and the fibers thereof are strong and will not be deformed when the web 15 is pulled so that the elastic substrate 12 is firmly attached to the web 15 and that the three-dimensional texture 121 is retained.

Since the substrate 12 is attached to the web 15 that is only 0.20 mm thick, the decorative laminate 10 can be used in various packages. In addition, the three-dimensional texture 121 can be made as a replica of texture made of carbon fibers and provided on personal computers and notebook computers so that they provide novel appearances.

The method for making an ultra thin decorative laminate exhibits several advantages. Firstly, the three-dimensional texture of the substrate is impressive. Secondly, the resultant decorative laminate is strong and durable since the substrate is attached, by the adhesive layer, to the web that is made strong fibers. Thirdly, the resultant decorative laminate is beautiful, water-proof and not vulnerable to dirt since various pigments can be added to the substrate. Fourthly, the resultant decorative laminate can be attached to various products since the ultra thin substrate is excellently extensible. Accordingly, the resultant decorative laminate can be used in quality hand-made grips, toys, fixtures of vehicles and housing and electronic products.

The present invention has been described via the detailed illustration of the embodiments. Those skilled in the art can derive variations from the embodiments without departing from the scope of the present invention. Hence, the embodiments shall not limit the scope of the present invention defined in the claims.

What is claimed is:

1. A method for making an ultra thin decorative laminate, the method comprising the steps of:
providing releasing paper with three-dimensional texture;
coating a substrate on the releasing paper;
drying the releasing paper and the substrate;
coating an elastomer layer on the substrate;
drying the releasing paper, the substrate and the elastomer layer so that the substrate and the elastomer layer are cured and become films; and
removing the releasing paper so that three-dimensional texture on the substrate is exposed, thus finishing an ultra thin decorative laminate that can firmly attached to a curved face of a product.

2. The method according to claim 1 wherein the elastomer layer is made from a material selected from a group consisting of duo-solution resin, thermoplastic elastomer, thermoplastic rubber, thermoplastic polyurethane, thermoplastic vulcanized elastomer, styrene-butadiene rubber, styrene-ethylene-butylene-styrene elastomer or styrene-isoprene-styrene.

3. The method according to claim 1 wherein the releasing paper, the substrate and the elastomer layer are dried at 80 to 130 degrees Celsius for 3 to 6 minutes.

4. The method according to claim 1 wherein the substrate is made from a material selected from a group consisting of polyurethane, thermoplastic polyurethane and thermoplastic elastomer.

5. The method according to claim 4 comprising the step of adding at least one pigment to the substrate before the step of coating the substrate on the releasing paper.

6. The method according to claim 1 wherein the releasing paper and the substrate are dried at 70 to 100 degrees Celsius for 3 minutes.

7. The method according to claim 1 wherein the thickness of the substrate is 0.05 mm to 0.1 mm.

8. An ultra thin decorative laminate comprising:
a substrate made of a polymer and made with three-dimensional texture and a thickness of 0.05 mm to 0.1 mm; and
an elastomer layer made of a thermoplastic elastomer and formed on the substrate opposite to the three-dimensional texture to provide the substrate with excellent extensibility so that the ultra thin decorative laminate is water-proof and excellently elastic.

9. The ultra thin decorative laminate according to claim 8 wherein the substrate is made from a material selected from a group consisting of polyurethane, thermoplastic polyurethane and thermoplastic elastomer.

10. The ultra thin decorative laminate according to claim 8 wherein the elastomer layer is made from a material selected from a group consisting of polyurethane resin, thermoplastic elastomer, thermoplastic rubber, thermoplastic polyurethane, thermoplastic vulcanized elastomer, styrene-butadiene rubber, styrene-ethylene-butylene-styrene elastomer or styrene-isoprene-styrene.

11. A method for making an ultra thin decorative laminate, the method comprising the steps of:
providing releasing paper with three-dimensional texture;
coating a substrate on the releasing paper;
drying the releasing paper and the substrate;
coating an adhesive layer on the substrate;
drying the releasing paper, the substrate and the adhesive layer so that the substrate and the adhesive layer are cured;
providing a web on the adhesive layer by rolling;
drying the releasing paper, the substrate, the adhesive layer and the web so that the web is cured; and
removing the releasing paper so that three-dimensional texture on the substrate is exposed.

12. The method according to claim 11 wherein the substrate is made from a material selected from a group consisting of polyurethane, thermoplastic polyurethane and thermoplastic elastomer.

13. The method according to claim 11 comprising the step of adding at least one pigment to the substrate before the step of coating the substrate on the releasing paper.

14. The method according to claim 11 wherein the releasing paper and the substrate are dried at 70 to 100 degrees Celsius for 3 minutes.

15. The method according to claim 11 wherein the adhesive layer is made from a material selected from a group consisting of polyurethane, thermoplastic polyurethane and thermoplastic elastomer.

16. The method according to claim 11 wherein the releasing paper, the substrate and the adhesive layer are dried at 50 to 100 degrees Celsius for 4 to 5 seconds.

17. The method according to claim 11 wherein the web is a fabric made of a material selected from a group consisting of synthetic and natural fibers, wherein the thickness of the fabric is not greater than 0.20 mm.

18. The method according to claim 11 wherein the releasing paper, the substrate, the adhesive layer and the web are dried at 80 to 130 degrees Celsius for 3 to 6 minutes.

19. The method according to claim 11 wherein the thickness of the ultra thin decorative laminate is not larger than 0.3 mm.

20. The method according to claim 11 wherein the web is an elastomer made from a material selected from a group consisting of polyurethane, duo-solution resin, thermoplastic elastomer, thermoplastic rubber, thermoplastic polyurethane, thermoplastic vulcanized elastomer, styrene-butadiene rubber, styrene-ethylene-butylene-styrene elastomer or styrene-isopiene-styrene.
